(19) United States
(12) Patent Application Publication
(10) Pub. No.: US 2012/0128076 A1
(43) Pub. Date: May 24, 2012

(54) APPARATUS AND METHOD FOR REDUCING BLOCKING ARTIFACTS

(75) Inventors: Piergiorgio SARTOR, Fellbach (DE); Francesco MICHIELIN, Padova (IT)

(73) Assignee: SONY CORPORATION, Tokyo (JP)

(21) Appl. No.: 13/295,759

(22) Filed: Nov. 14, 2011

(30) Foreign Application Priority Data
Nov. 23, 2010 (EP) 10192154.2

(51) Int. Cl. H04N 7/26

(52) U.S. Cl. 375/240.24; 375/E07.193

(57) ABSTRACT

The present invention relates to an apparatus for reducing blocking artifacts in a coded video signal comprising a plurality of video frames. An apparatus is proposed comprising a wavelet decomposition unit that decomposes an input video frame by use of wavelet decomposition into at least two frequency bands, a block grid detector that detects block borders in at least one high frequency band of said at least two frequency bands, a deblocking unit that equalizes the energy of detected block borders with the energy of neighboring areas of the same high frequency band to obtain processed frequency bands to reduce blocking artifacts in said video frame, and a wavelet composition unit that composes an output video frame from said input video frame and said processed frequency bands by use of wavelet composition.

### CROSS-REFERENCE TO RELATED APPLICATIONS

The present application claims priority of European patent application 10192154.2 filed on Nov. 23, 2010.

### FIELD OF THE INVENTION

The present invention relates to an apparatus and a corresponding method for reducing blocking artifacts in a coded video signal comprising a plurality of video frames. Further, the present invention relates to a computer program for implementing said method and a computer readable non-transitory medium storing such a computer program.

### BACKGROUND OF THE INVENTION

Coded digital video streams can have, especially at high compression level, but also due to poor encoding tuning, several disturbing artifacts. One of the most apparent artifacts, besides ringing, or mosquito noise, artifacts, is the blocking of the picture. This appears as a mosaicization of the image. Several techniques can be used to reduce these artifacts, usually working either in the coded domain or in the baseband domain. The problem with the coded domain is that the deblocking must have access to the encoder information, which is not always the case. On the other hand, working on the baseband can avoid the encoder information, but it also tends to reduce, together with the blocking artifacts, also the texture and sharpness of the images.

The usual technique to reduce such blocking artifacts is to identify the block border and low-pass the picture across the border (orthogonal to the border). This process low-passes the content of the block. If the block contains texture, this could, however, be smoothed, causing secondary unwanted blurring artifacts.

### BRIEF DESCRIPTION OF THE INVENTION

It is an object of the present invention to provide an apparatus and a corresponding method for reducing blocking artifacts in a coded video signal comprising a plurality of video frames while keeping any texture in the coded video signal intact. It is a further object of the present invention to provide a computer program as well as a corresponding computer readable non-transitory medium for implementing said method.

According to an aspect of the present invention there is provided an apparatus for reducing blocking artifacts in a coded video signal comprising a plurality of video frames, comprising
a wavelet decomposition unit that decomposes an input video frame by use of wavelet decomposition into at least two frequency bands,
a block grid detector that detects block borders in at least one high frequency band of said at least two frequency bands,
a deblocking unit that equalizes the energy of detected block borders with the energy of neighboring areas of the same high frequency band to obtained processed frequency bands to reduce blocking artifacts in said video frame, and
a wavelet composition unit that composes an output video frame from said input video frame and said processed frequency bands by use of wavelet composition.

According to a further aspect of the present invention there is provided a corresponding method for reducing blocking artifacts in a coded video signal comprising a plurality of video frames.

According to a further aspect of the present invention there is provided an apparatus for reducing blocking artifacts in a coded video signal comprising a plurality of video frames, comprising
a wavelet decomposition means for decomposing an input video frame by use of wavelet decomposition into at least two frequency bands,
a block grid detection means for detecting block borders in at least one high frequency band of said at least two frequency bands,
a deblocking means for equalizing the energy of detected block borders with the energy of neighboring areas of the same high frequency band to obtained processed frequency bands to reduce blocking artifacts in said video frame, and
a wavelet composition means for composing an output video frame from said input video frame and said processed frequency bands by use of wavelet composition.

According to still further aspects a computer program comprising program means for causing a computer to carry out the steps of the method according to the present invention, when said computer program is carried out on a computer, as well as a computer readable non-transitory medium having instructions stored thereon which, when carried out on a computer, cause the computer to perform the steps of the method according to the present invention are provided.

Preferred embodiments of the invention are defined in the dependent claims. It shall be understood that the claimed method, the claimed computer program and the claimed computer readable medium have similar and/or identical preferred embodiments as the claimed apparatus and as defined in the dependent claims.

The present invention is based on the idea to use the wavelet domain to identify the block borders and corners in the coded pictures, in particular video frames of a video stream. It tries, still in the wavelet domain, to equalize the energy of the borders and/or corners of the block with the energy of the centre of the block. This allows to reduce or to eliminate the blocking effect while keeping the texture intact.

### BRIEF DESCRIPTION OF THE DRAWINGS

These and other aspects of the present invention will be apparent from and explained in more detail below with reference to the embodiments described hereinafter. In the following drawings

FIG. 1 shows a first embodiment of an apparatus according to the present invention,

FIG. 2 shows a diagram illustrating the general steps of a wavelet transform and of a wavelet antitransform,

FIG. 3 shows an example of the application of a two-dimensional wavelet decomposition,

FIG. 4 shows representations of an edge, a block border and texture in the wavelet domain,

FIG. 5 shows diagonal, vertical and horizontal details of a block grid in an image,

FIG. 6 shows an image frame of a high frequency band obtained by wavelet decomposition,

FIG. 7 illustrates an embodiment of deblocking for a vertical block border,

FIG. 8 illustrates an embodiment of deblocking for a horizontal block border,

FIG. 9 illustrates an embodiment of debocking for a block border crossing,

FIG. 10 shows images before and after deblocking,

FIG. 11 shows two rows of (different numbers) of pixels for illustrating energy equalization,

FIG. 12 shows a second embodiment of an apparatus according to the present invention,

FIG. 13 shows DC blocks in the diagonal details,

FIG. 14 shows DC blocks in the vertical details, and

FIG. 15 shows DC blocks in the horizontal details.

### DETAILED DESCRIPTION OF THE INVENTION

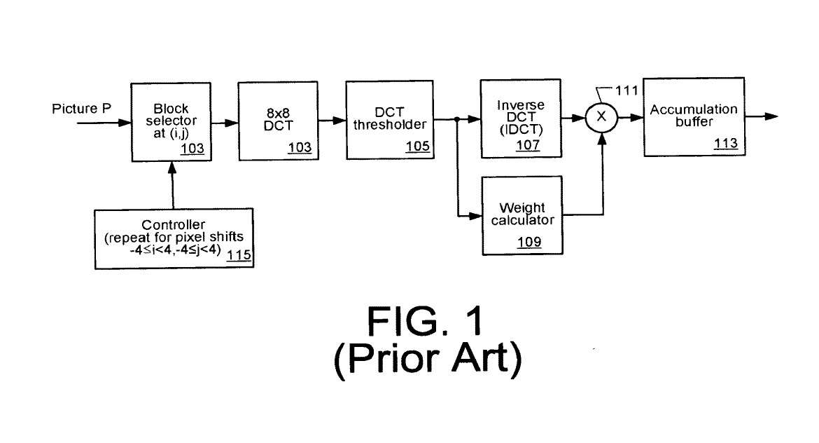

FIG. 1 shows a first embodiment of an apparatus 10 for reducing blocking artifacts in a coded video signal 1 comprising a plurality of video frames. Said apparatus 10 comprises a wavelet decomposition unit 12 (preferably a 2D wavelet decomposition unit) that decomposes an input video frame by use of wavelet decomposition into at least two frequency bands. A block grid detector 14 that is coupled to the output of the wavelet decomposition unit 12 detects block borders in at least one high frequency band of said at least two frequency bands. A deblocking unit 16 equalizes the energy of detected block borders with the energy of neighboring areas of the same high frequency band to obtain processed frequency bands to reduce blocking artifacts in said video frame. Finally, a wavelet composition unit 18 is provided that composes an output video frame of an output video signal 2 from said input video frame of the video signal 1 and said processed frequency bands by use of wavelet composition.

Wavelets are generally known in the art. Generally, a wavelet is a mathematical function used to divide a given function or continuous-time signal into different scale components. Usually, a frequency range (frequency band) can be assigned to each scale component. Each scale component can then be studied with a resolution that matches its scale. A wavelet transform is the representation of a function by wavelets. The wavelets are scaled and translated copies (known as “daughter wavelets”) of a finite-length or fast-decaying oscillating waveform (known as “mother wavelet”). Wavelet transforms have advantages over traditional Fourier transforms for representing functions that have discontinuities and sharp peaks, and for accurately deconstructing and reconstructing finite, non-periodic and/or non-stationary signals. There are a large number of wavelet transforms, such as discrete wavelet transforms (DWTs) and continuous wavelet transforms (CWTs).

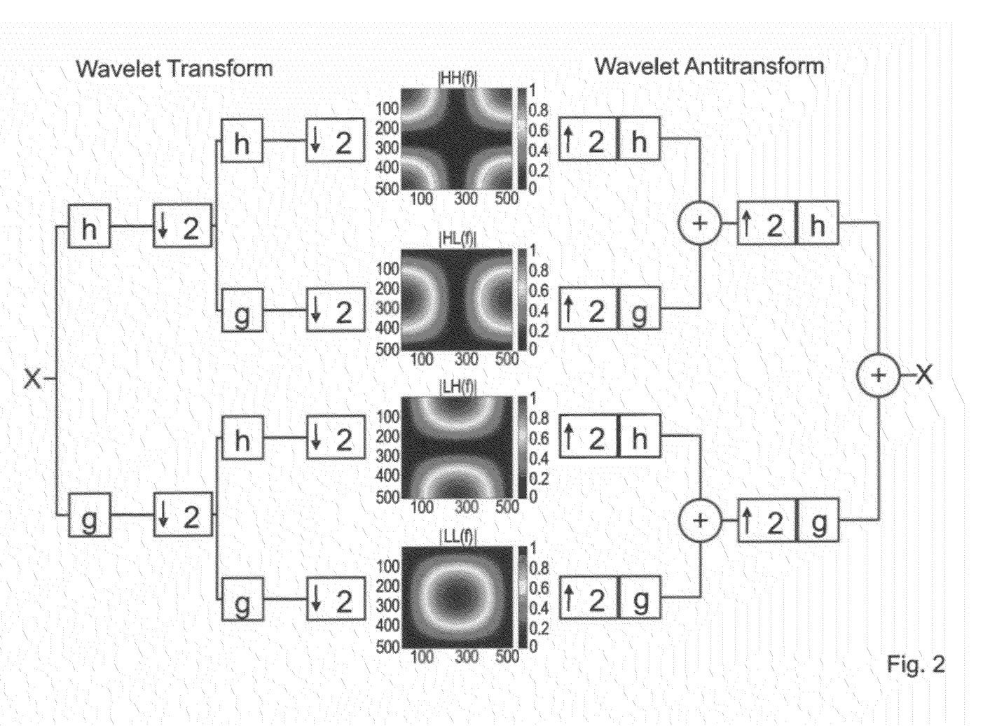

FIG. 2 shows a diagram illustrating the general steps of a wavelet trans-form and of a wavelet antitransform. A wavelet transform (e.g. DWT) of a signal x is calculated by passing it through a series of filters. First, the samples are passed through a low pass filter with impulse response g resulting in a convolution of the signal x with the impulse response g. The signal x is also decomposed simultaneously using a high pass filter h. The outputs of the filters g and h are the detail components (from the high pass filter h) and the approximation coefficients (from the low pass filter g). These two filters are generally related to each other and sometimes known as quadrature mirror filter. Since half the frequencies of the signal have now been removed, half the samples can generally be discarded according to Nyquist's rule. The filter outputs are then subsampled by 2. This decomposition has half the time resolution since only half of each filter output characterizes the signal. However, each output has half the frequency band of the input signal x, i.e. the frequency resolution has been doubled. This decomposition can be repeated one or more times to further increase the frequency resolution of the approximation coefficients decomposed with high and low pass filters and then downsampled.

Wavelet packet decomposition (WPD) is a wavelet transform where the signal is passed through more filters than in the discrete wavelet transform. In the DWT, each level is calculated by passing only the previous approximation coefficient, i.e. the output of the low pass filter path, through low and high pass filters. However, in the WPD, both the detail coefficient and the approximation coefficient, i.e. the outputs of both the low pass and the high pass filters, are decomposed. Four n levels of decomposition, the WPD produces 2ⁿ different sets of coefficients (or nodes).

FIG. 2 shows an embodiment of such a wavelet packet decomposition (also referred to as wavelet decomposition or wavelet transform hereinafter) for two levels and a corresponding wavelet packet composition (also referred to as wavelet composition or wavelet antitransform hereinafter). This wavelet packet decomposition and the wavelet composition are two-dimensional, for a single step corresponds to two steps of a wavelet packet decomposition and the wavelet composition. The four frequency bands (also called channels) obtained by the wavelet decomposition are indicated by HH, HL, LH and LL, H indicating the output of a high pass filter and L indicating the output of a low pass filter, wherein the frequency band LL shows the approximation coefficients, the frequency band LH shows horizontal details, the frequency band HL shows vertical details and the frequency band HH shows diagonal details.

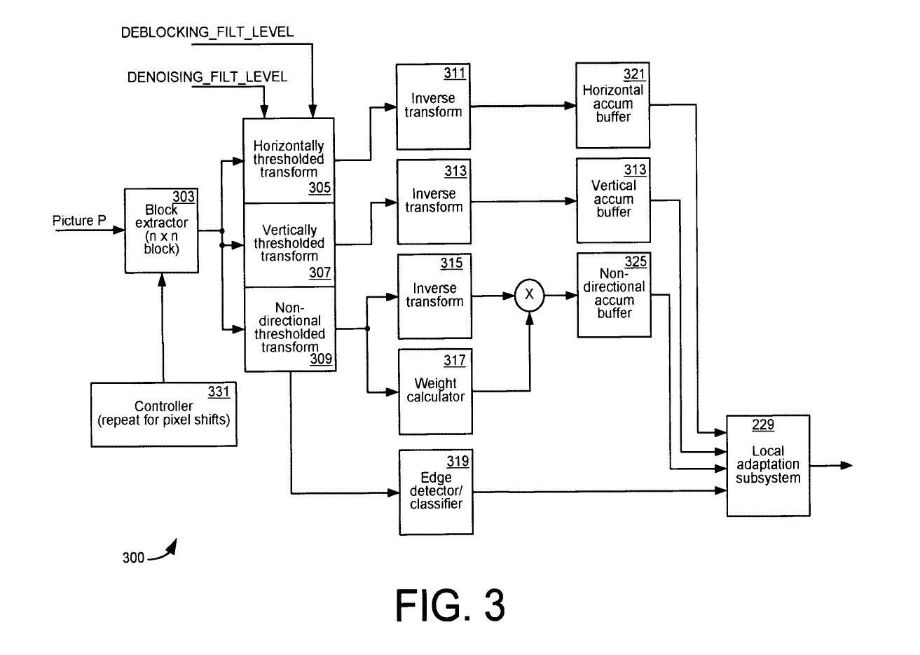

FIG. 3 shows an example of the application of a two-dimensional wavelet decomposition of an original image resulting in four frequency bands LL₁, LH₁, HL₁, HH₁ after a first stage, wherein the LL₁ frequency band is further decomposed into four frequency band LL₂, LH₂, HL₂, HH₂ in a second stage.

According to the present invention the wavelet decomposition unit 12 is generally adapted for applying a 2D wavelet decomposition by which the input video frame 1 is decomposed into four frequency bands. Instead of applying a 2D wavelet decomposition two times a 1D wavelet decomposition can be applied as well, wherein in each stage a decomposition in two frequency bands is performed. Generally, also a 3D wavelet decomposition is, at least theoretically, possible.

Preferably, according to the present invention, no subsampling is applied by the wavelet decomposition unit as is generally the case. Subsampling is invariant in case of linear operations, but according to the present invention the processing includes wavelet decomposition in a non-linear fashion. Hence, no subsampling is preferred to keep all the information and not to lose any information. Furthermore, no subsampling allows to exploit the local correlation of the input video frame. Finally, subsampling the wavelet removes the phase information, which is preferred in case of moving sequences.

Further, the wavelet decomposition is preferably iteratively applied, e.g. the input video frame of the input video is iteratively decomposed by use of a cascade of at least two wavelet decompositions in a plurality of frequency bands of at least two levels. Further, preferably at least the lowest frequency band (in the embodiment shown in FIG. 3 the LL₁ frequency band) of a particular level is decomposed into at least two frequency band of the subsequent level (in the embodiment shown in FIG. 3 the LL₁ frequency band is decomposed into frequency bands LL₂, LH₂, HL₂, HH₂ of the subsequent level). The number of decompositions and levels can thus be selected by the user, for instance dependent on the desired level of accuracy of a block artifact reduction.

Generally, several types of wavelet transforms can be applied according to the present invention. In practical embodiments Le Gall 5/3 and Daubechies 9/7 wavelet transforms deliver good results. Preferably, wavelets are used which are shorter, at least for the high-pass part, than the block size, i.e. for example which have less than 8 pixels for the short part, in order to avoid to cross multiple block borders.

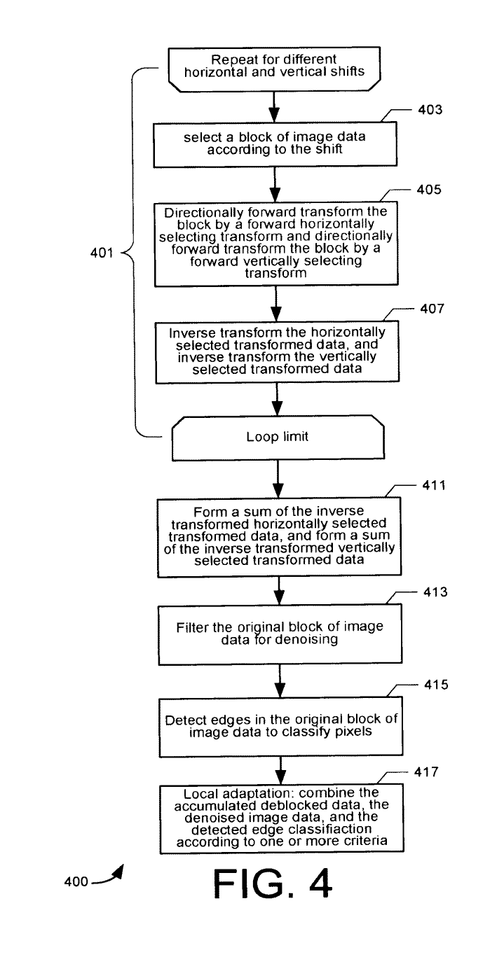

FIG. 4 illustrates how an edge, a block border and texture is represented in the wavelet domain, in particular in a high pass channel (Hp) and in low pass channel (Lp). The idea of the present invention is to exploit the correlation between a border and what there is in the image frame. In particular, it has been recognized that it is possible to equalize the activity in the wavelet domain instead of using low pass filters in it or even in the original image. A lot of known deblocking algorithms are just block border adapters, in other words they change the type of filtering with a size of the block border. For this reason they do not work well in texture areas because they low pass too much a texture or they leave the structure. Instead, the proposed solution results are adaptive at the same time on the block border and the surrounding areas exploiting that there is more activity intrinsic in the block border in the wavelet domain compared to texture areas. After the wavelet decomposition block detection is performed by the block grid detector 14, i.e. block borders are detected in at least one high frequency band of at least two frequency bands obtained by the wavelet decomposition. Those block borders are generally quite easily recognizable since such a block grid or block border is generally quite regular, i.e. the information about the block borders is correlated. Knowledge about how a block border is represented in the wavelet domain (as shown in FIG. 4) may also be exploited to detect the block borders.

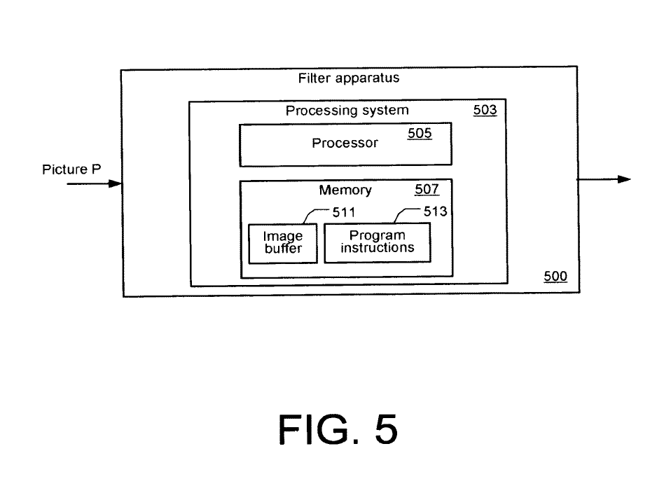

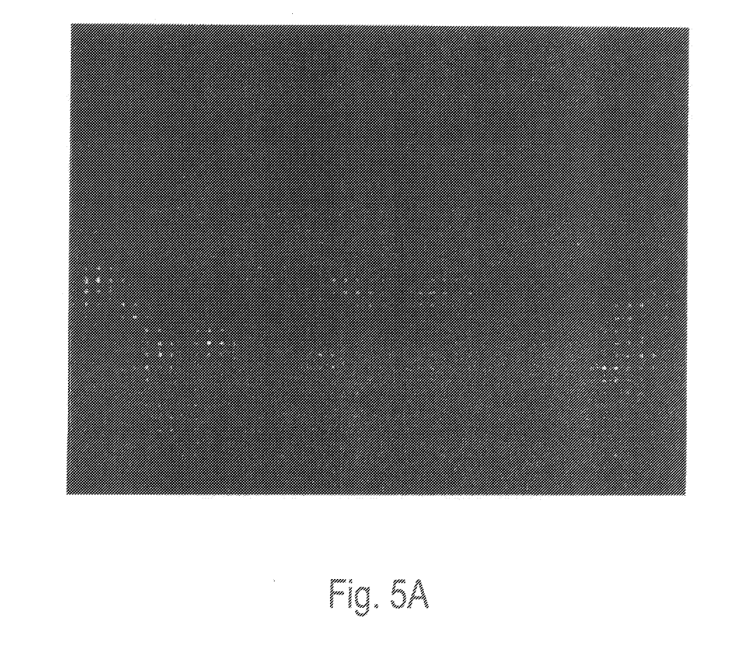

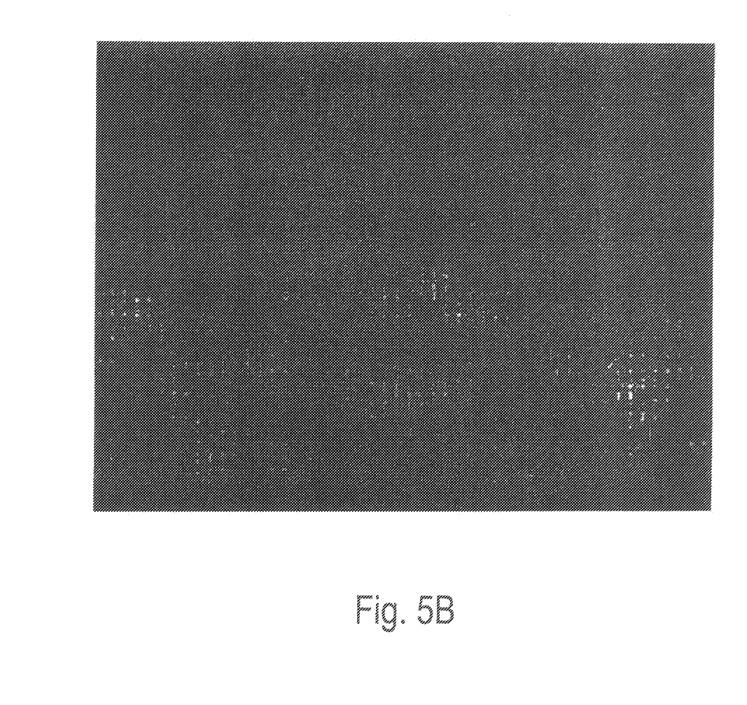

Examples of diagonal details of a block grid are shown in FIG. 5A, examples of vertical details of a block grid are shown in FIG. 5B, and examples of horizontal details of a block grid are shown in FIG. 5C.

An exemplary embodiment explaining how to obtain block border information is explained in the following. A deblocking algorithm can not avoid to know where the blocks are and for this a pre-analysis for their location is needed. The first wavelet iteration, with its detail coefficients, provides a lot of information on the position of the blocks, in fact, as it is possible to see in FIGS. 5A, 5B, 5C, their structure is really evident. These figures are the results of convolution of the original image with Le Gall 5/3 filters. The choice of Le Gall filter taps is preferred because, even if Daubechies 9/7 have a better frequency response these last lead, especially for 8×8 blocks, to a blending of the block borders due to the high number of taps. Thinking about how a block border is represented in the wavelet domain (see FIG. 4), the idea is to exploit the correlation between this perfect border an what there is in the image.

Of course every detail coefficient has its own characteristics and so a different procedure, as it will be explained in the following, can be iterated. Moreover, the amount of correlation can also intrinsically provide a level of blockiness. It is then possible to use this information to apply or not a stronger deblocking algorithm which, in the wavelet domain, leads to iterate the wavelet decomposition more or less often.

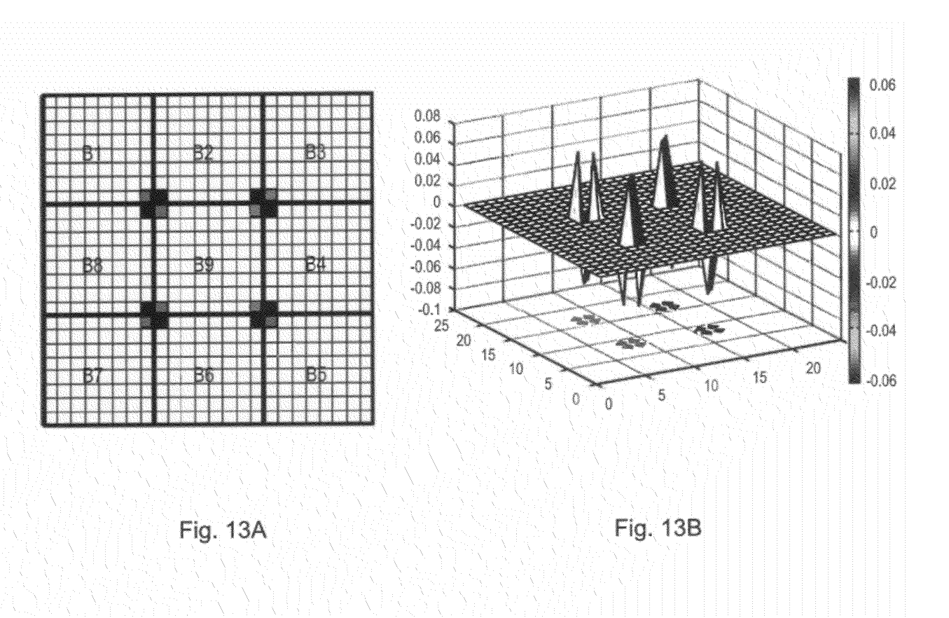

A filtering on the row and on the columns with a high-pass wavelet filter produces the diagonal details. These usually comprise the four block corners of a perfect block as shown in FIG. 13A. This special situation is not so common in a normal image because not only perfect blocks are present and so there should be also some activity in the center of the block. Anyway, the energy at the block corners is bigger than the one inside and presents a particular pattern. For this reason it is proposed to exploit the correlation with the block corners of a perfect block towards the following equations

A=HH(x−4,y−4)−HH(x−3,y−4)+HH(x−3,y−3)−HH(x−4,y−3)

B=HH(x−4,y+4)−HH(x−3,y+4)+HH(x−3,y+5)−HH(x−4,y+5)

C=HH(x+4,y−4)−HH(x+5,y−4)+HH(x+5,y−3)−HH(x+4,y−3)

D=HH(x+4,y+4)−HH(x+5,y+4)+HH(x+5,y+5)−HH(x+4,y+5)

and

Block-Corner(x,y)=|A|+|B+|C+|D|

This method produces a diagram as shown in FIG. 13B in which the block corners are extremely visible even in the texture areas. After that, in order to find the most probably position of the blocks, for every 8×8 area the maximum activity in FIG. 13b is researched and the row and column offsets in the area stored. With the knowledge of the offsets for every 8×8 area of the image is then possible to define the more common row offset (DROffset), column offset (DCOffset) and their reliability (DRCOffset % and DCOffset %) as the overall ratio.

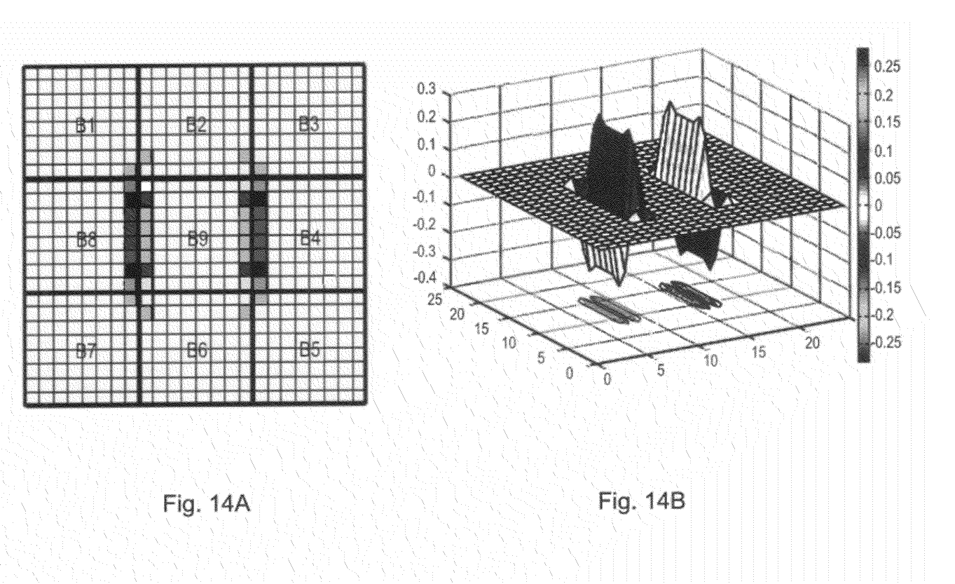

The vertical coefficients are the results of a row convolution with a high-pass wavelet filter and a column convolution with a low-pass wavelet filter. For this reason the prevalent directions are vertical and so it is appropriate to detect the vertical block borders. Now, as before, the following equations calculate the correlation with the perfect block border as shown in FIGS. 14A, 14B.

A=−HL(x,y−4)+HL(x,y−3)

B=HL(x,y+4)−HL(x,y+5)

and

VerticalBlockBorder(x,y)=A+|B|,

This iteration provides the FIG. 5B and from this the calculation of the maximum activity in every 1×8 area gives the most common column offset (VCOffset) and its reliability (VCOffset %).

The horizontal coefficients are exactly the orthogonal version of the vertical coefficients. In fact the low-pass filtering is on the rows and the high-pass is on the columns. This filtering points out the horizontal structures like horizontal block borders. The amount of correlation as calculated by the following equations

A=−LH(x−4,y)+LH(x−3,y)

B=LH(x+4,y)−LH(x+5,y)

and

HorizontalBlockBorder(x,y)=|A|+|B

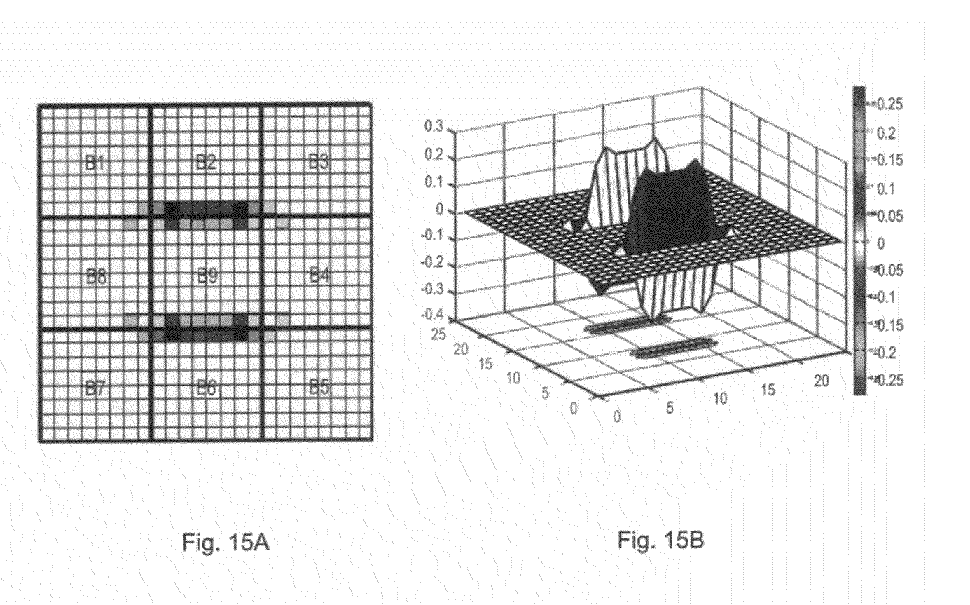

is shown in FIG. 5C and from it the maximum activity in every 8×1 area gives the most common row offset (HROffset) and its reliability (HROffset %). The correlation with the perfect block border is shown in FIGS. 15A, 15B.

At this point, having the blocking knowledge of the detail coefficients of the first wavelet iteration, it is necessary to merge the previous results in one which points out the amount of blockness in the image. For example, the following relations provide a reliable result:

BlockLevel=2 if DROffset=HROffset with DROffset %,HROffset %>75%̂DCOffset=VCOffset with DCOffset %,VCOffset %>75%

BlockLevel=1 if DROffset=HROffset with DROffset %,HROffset %>50%̂DCOffset=VCOffset with DCOffset %,VCOffset %>50%

BlockLevel=0 otherwise

Generally, it is possible to detect block borders also in the low frequency band. However, generally block borders have high frequency content and are more easily to detect in high frequency bands, because in the low frequency band picture information merges with block border information.

Next, by use of the detected block borders the energy of detected block borders is equalized with the energy of neighboring areas of the same high frequency band to obtain processed frequency bands to reduce blocking artifacts in the video frame. Generally, the equalization is done only in the high frequency bands, but not in the lowest frequency band. However, the information about block borders may be carried over to other frequency bands, i.e. block border information obtained from a particular frequency band can also be used for equalization of another frequency band.

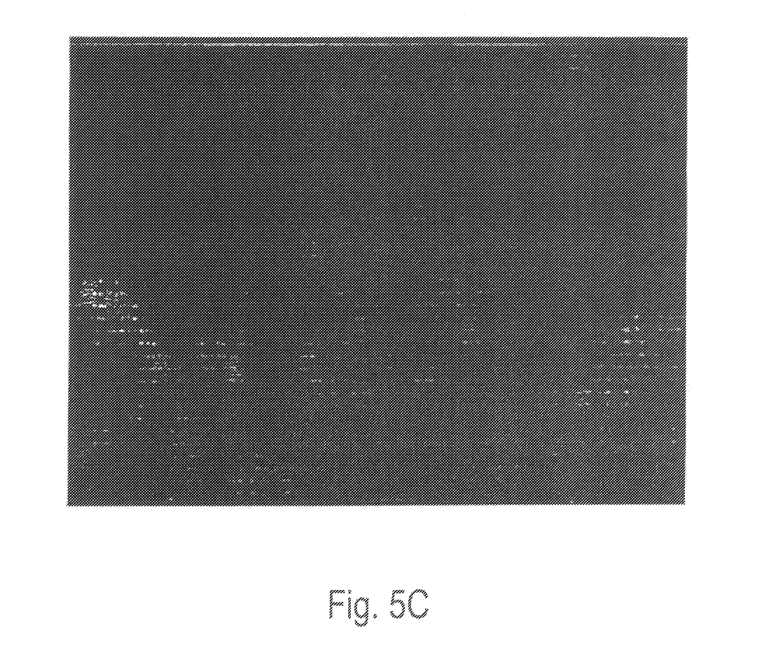

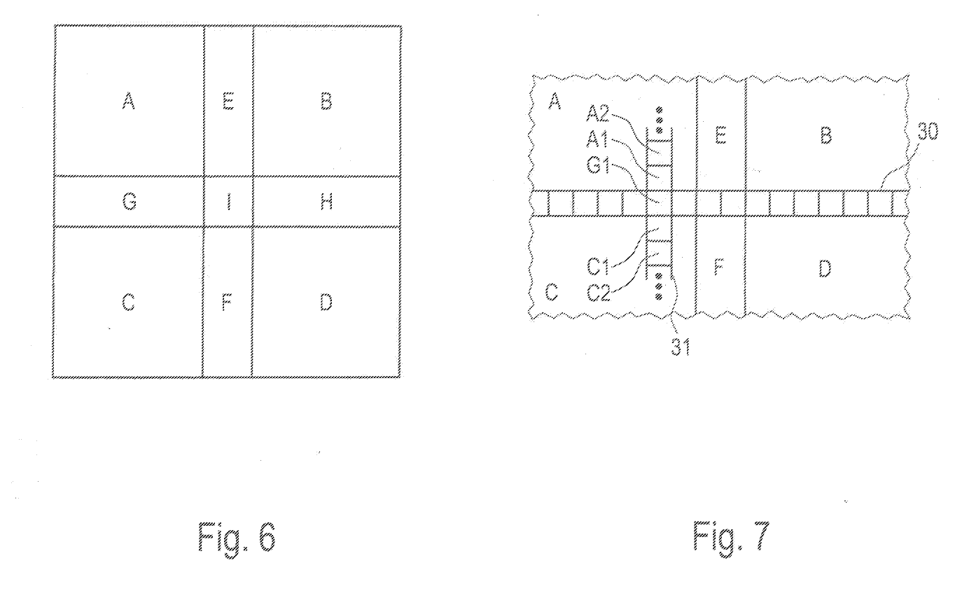

An embodiment of the deblocking as performed by the deblocking unit 16 according the present invention shall be explained with reference to FIGS. 6 to 9. FIG. 6 shows an image frame of a high frequency band obtained by wavelet decomposition according to the present invention in which block borders have been detected by the block detector according to the present invention. Only a small area of such an image frame is depicted for better illustration. Said image is divided into various areas, wherein the areas A, B, C, D are image areas without any block borders and the areas E, F, G, H, I are areas in which block borders have been identified. Preferably, those block borders have been enlarged to result in those block border areas E, F, G, H, I. The areas E, I, F thus represent a vertical block border, the areas G, I, H represent a horizontal block border and the area I represents a block border crossing.

The general idea for deblocking as proposed according to the present invention is to equalize the energy of detected block borders with the energy of neighboring areas. FIG. 7 illustrates how this is applied for deblocking a horizontal block border 30, i.e. a block border along the areas G, I, H. Particularly, the energy of detected block borders is equalized with the energy of directly neighboring areas, preferably of areas which are substantially arranged in directions perpendicular to the detected block border. Considering, for example, the pixel G₁ of the horizontal block border 30 this means that the energy of this pixel G₁ is equalized with the energy of neighboring pixels of the areas A, C, in particular with pixels of the column 31 which is arranged perpendicular to the block border 30 and which goes through pixel G₁. Thus, in an embodiment at least the energy of the pixels A₁ and C₁ is used for this equalization. In other embodiments, the energy of two or more pixels of the column 31 in both neighboring areas A and C is used for this equalization, e.g. the energy of all pixels of said column 31 in the two neighboring areas A and C is used for this purpose. In still another embodiment the energy of the complete areas A and C (but preferably not of any further more distant areas) is used for equalization of the energy of pixel G₁ and, in this case, all pixels of the block border area G.

Preferably, for equalizing the energy of detected block borders the mean, median, maximum or minimum of the energy of directly neighboring areas (or portions of neighboring areas) is used.

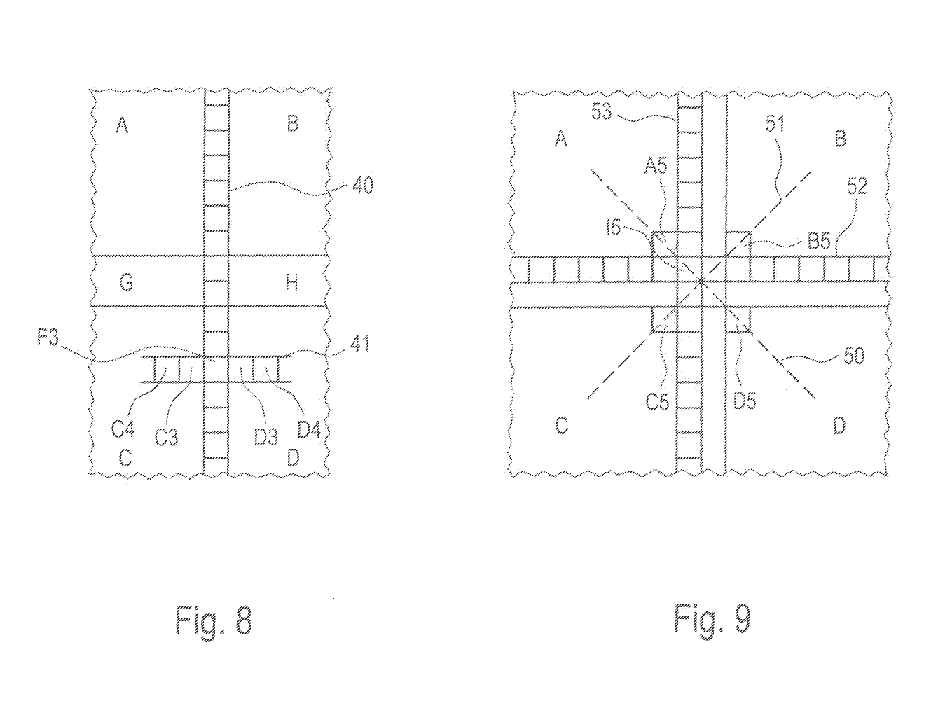

FIG. 8 shows an example of the application of deblocking as proposed according to the present invention to a vertical block border 40. Generally, the procedure is the same as is explained with respect to a horizontal block border 30 as shown in FIG. 7. In particular, considering a certain pixel F₃ of the detected block border 40 the energy of this pixel F₃ is equalized by use of the energy of neighboring pixels, particularly of the same row 41 that extends in a direction perpendicular to the block border 40. For instance, in an embodiment the energy of neighboring pixels C₃ and D₃ is used for this equalization, whereas in other embodiments the energy of two or more (e.g. all) pixels of the row 41 in the areas C and D is used for this equalization. In still another embodiment the energy of all pixels of the complete areas C and D is used for this purpose.

FIG. 9 illustrates the application of deblocking as proposed according to the present invention on a block border crossing (e.g. the area I). For instance, considering the pixel I₅ of the block border crossing, the energy of this pixel I₅ is equalized by use of the energy of pixels from the neighboring areas A, B, C, D, in particular of pixels which are substantially arranged in directions of the bisecting lines 50, 51 of said block border crossing. For instance, for equalization of the energy of pixel I₅ the energy of neighboring pixels A₅, B₅, C₅ and D₅ is used. In other embodiments the energy of more pixels of the areas A, B, C, D, preferably of the closest pixels, or, in still another embodiment, of all pixels of those areas are used.

In still another embodiment the energy of pixel I₅ is equalized by use of the energy of pixels of the same row 52 and column 53. Since the pixels of this row 52 and this column 53 do also belong to block borders, it is preferably provided in this embodiment that these pixels are dealt with first, i.e. that their energy is equalized as explained above with reference to FIGS. 7 and 8, and that then in a subsequent step the energy of the pixel I₅ (in general, the energy of pixels of a block border crossing) is equalized by use of the equalized energy of those neighboring areas of a vertical and a horizontal block border leading through said block border crossing.

Still further, in another embodiment the energy of the pixels of the block border crossing is equalized by the use of the energy of the complete areas A, B, C, D and/or the complete areas E, F, G, H.

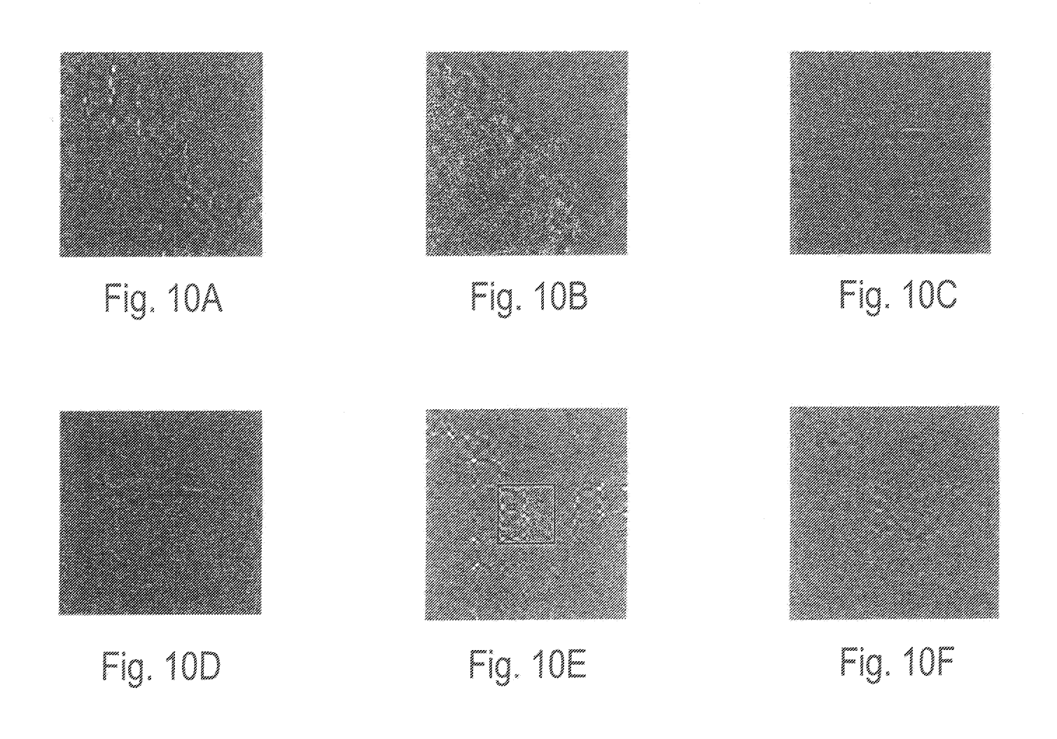

FIG. 10 shows exemplarily images illustrating the effect of the deblocking as explained above. FIG. 10A shows an image with clearly visible vertical block borders which are much less visible in the image shown in FIG. 10B in which vertical block borders have been deblocked. FIG. 10C shows an image with clearly visible horizontal block borders, which have been deblocked in the image shown in FIG. 10D. FIG. 10E shows an image with clearly visible diagonal details, i.e. including horizontal and vertical block borders and block border crossings, which have been deblocked in the image shown in FIG. 10F.

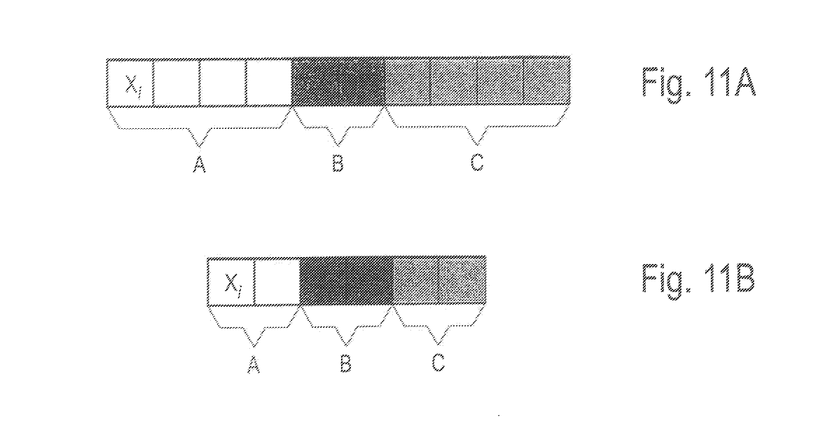

In the following, by reference to FIGS. 11A and 11B showing a row of (different numbers) of pixels, two simple examples are given to explain that the areas considered can change. Usually the area B which is related to the block borders does not change. Moreover, this area B is related to the wavelet type, e.g. a Le Gall 5/3 wavelet, which provides a block border expansion of two pixels in the first wavelet iteration. Of course going further with the decomposition causes a larger expansion and then a bigger block border area B should be considered.

In the following explanation an area will be indicated with a capital letter, A, as well known in the set theory, and a lowercase letter, a, will refer to the absolute moment (or energy) of the first order of the pixels which belong to the correspondent capital letter.

Three different examples (there are further examples available) of energy calculation are:

$$a = {\sum }_{x ∈ A} \frac{\vert x \vert}{‖ A ‖} , b = {\sum }_{x ∈ B} \frac{\vert x \vert}{‖ B ‖} , c = {\sum }_{x ∈ C} \frac{\vert x \vert}{‖ C ‖}$$

$$a = \vert {x}_{1} - {x}_{2} \vert , {x}_{i} ∈ A , b = \vert {x}_{1} - {x}_{2} \vert , {x}_{i} ∈ B , c = \vert {x}_{1} - {x}_{2} \vert , {x}_{i} ∈ C$$

$$a = {\sum }_{{x}_{i} ∈ A} \frac{\vert {x}_{i} - {x}_{i + 1} \vert}{n} , b = {\sum }_{{x}_{i} ∈ B} \frac{\vert {x}_{i} - {x}_{i + 1} \vert}{n} , c = {\sum }_{{x}_{i} ∈ C} \frac{\vert {x}_{i} - {x}_{i + 1} \vert}{n} ,$$

where n is the number of sums.

Different examples (there are further examples available) of equalization formulas are:

$$x = x \cdot \frac{a + b}{2 c} if x ∈ C$$

$$x = x \cdot \frac{min ( a , b )}{c} if x ∈ C$$

$$x = x \cdot \frac{max ( a , b )}{c} if x ∈ C$$

$$x = x \cdot \frac{median ( a , b , c )}{c} if x ∈ C$$

It is also possible to integrate more equalization formulas depending on other image information, as for example x∈edge or x∉edge.

After the deblocking the (deblocked) frequency bands are subjected to an inverse wavelet transform (wavelet composition) in the wavelet composition unit 18. Said wavelet composition is complementary to the wavelet decomposition of the wavelet decomposition unit 12 and reconstructs the image frame of the video output signal 2.

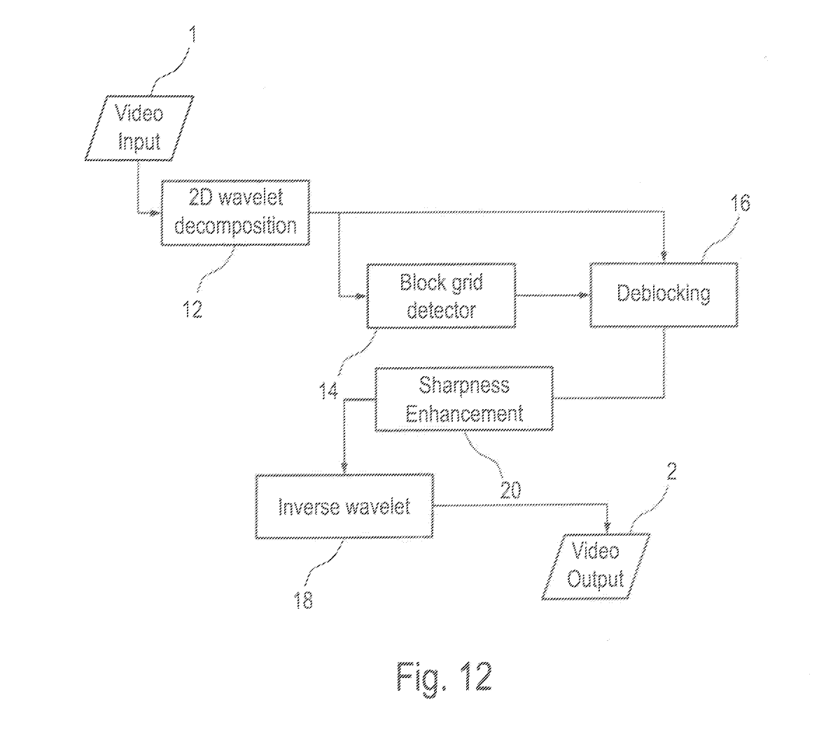

Using wavelets as proposed according to the present invention allows to easily perform, at the same time, other tasks in the wavelet domain, like noise reduction and sharpness enhancement. FIG. 12 shows an exemplary embodiment of an apparatus according to the present invention, which, in addition to the embodiment shown in FIG. 1, comprises an additional sharpness enhancement unit 20 for sharpness enhancement of the image frame after deblocking and before wavelet composition. Instead or in addition to the sharpness enhancement unit 20 other image processing means for image processing of the processed frequency bands and/or the input video frame in the wavelet domain may be provided in other embodiments, in particular for noise reduction, color saturation enhancement, hue enhancement, brightness enhancement and/or contrast enhancement, before wavelet composition.

It should be noted that according to the present invention YUV processing is possible (Y U V are the luminance and chrominance channels, respectively). In such an embodiment the information about blocking is derived from the Y channel, and the U and V channels is processed accordingly like the Y channel.

The proposed solution tries to exploit the wavelet decomposition in order to perform a better deblocking starting from the baseband domain, without any knowledge of the encoding which took place. The proposed method can, thanks to the wavelet decomposition, reduce the blocking while keeping the texture, which normally does not apply to conventional baseband methods. A further characteristic of the present invention is that the process is memory centric and not CPU centric, which is clearly useful for software applications running on a PC, where usually the memory is not a real problem, while the CPU might be used by several, uncontrollable tasks. This method, as mentioned before, is memory centric, trying to keep the computational load low, while using more memory. This approach makes it suitable for PC application.

The invention has been illustrated and described in detail in the drawings and foregoing description, but such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. An apparatus for reducing blocking artifacts in a coded video signal comprising a plurality of video frames, comprising:
a wavelet decomposition unit that decomposes an input video frame by use of wavelet decomposition into at least two frequency bands,
a block grid detector that detects block borders in at least one high frequency band of said at least two frequency bands,
a deblocking unit that equalizes the energy of detected block borders with the energy of neighboring areas of the same high frequency band to obtain processed frequency bands to reduce blocking artifacts in said video frame, and
a wavelet composition unit that composes an output video frame from said input video frame and said processed frequency bands by use of wavelet composition.

2. The apparatus as claimed in claim 1,
wherein said deblocking unit is operable to equalize the energy of detected block borders with the energy of directly neighboring areas, which are substantially arranged in directions perpendicular to said detected block border.

3. The apparatus as claimed in claim 1,
wherein said deblocking unit is operable to equalize the energy of detected block borders at block border crossings with the energy of directly neighboring areas, which are substantially arranged in directions of the bisecting lines of said block border crossings.

4. The apparatus as claimed in claim 1,
wherein said deblocking unit is operable to equalize the energy of detected block borders by using the mean, median, maximum or minimum of the energy of directly neighboring areas.

5. The apparatus as claimed in claim 1,
wherein said deblocking unit is operable to equalize the energy of detected block borders with the energy of directly neighboring areas, wherein the size of a directly neighboring area is determined by the block borders surrounding it.

6. The apparatus as claimed in claim 5,
wherein said deblocking unit is operable to equalize the energy of detected block borders with the energy of portions of directly neighboring areas, which portions are directly adjacent the block border, whose energy shall be equalized, and has a size of 10 to 90%, in particular 25 to 50% of the complete directly neighboring area.

7. The apparatus as claimed in claim 1,
wherein said deblocking unit is operable to equalize the energy of detected block borders pixel by pixel for the pixels of the detected block borders.

8. The apparatus as claimed in claim 7,
wherein said deblocking unit is operable to determine a corrected pixel value replacing the original pixel value of a pixel of a detected block border by use of the energy of pixels of directly neighboring areas of the same row and/or column.

9. The apparatus as claimed in claim 7,
wherein said deblocking unit is operable to determine a corrected pixel value replacing the original pixel value of a pixel of a detected block border crossing by use of the energy of pixels of directly neighboring areas, which are substantially arranged in directions of the bisecting lines of said block border crossings.

10. The apparatus as claimed in claim 7,
wherein said deblocking unit is operable to determine a corrected pixel value replacing the original pixel value of a pixel of a detected block border crossing by use of the energy of pixels of the directly neighboring portions of the blocks borders crossing in said block border crossing, for which pixels corrected pixel values have been determined in previously.

11. The apparatus as claimed in claim 1,
wherein said wavelet decomposition unit and said wavelet composition unit are operable to apply wavelets that are, at least for the high frequency band, shorter than the block size.

12. The apparatus as claimed in claim 1,
wherein said wavelet decomposition unit is operable to decompose an input video frame by use of wavelet decomposition without subsampling.

13. The apparatus as claimed in claim 1,
wherein said wavelet decomposition unit is operable to iteratively decompose an input video frame by use of a cascade of at least two wavelet decompositions into a plurality of frequency bands of at least two levels, wherein at least the lowest frequency band of a first level is decomposed into at least two frequency bands of a second level, and
wherein said block grid detector and said deblocking unit are operable to process at least one high frequency band of each level.

14. The apparatus as claimed in claim 1,
further comprising image processing means for image processing of the processed frequency bands and/or the input video frame in the wavelet domain, in particular for sharp-ness enhancement, noise reduction, color saturation enhancement, hue enhancement, brightness enhancement and/or contrast enhancement, before wavelet composition.

15. The apparatus as claimed in claim 1,
wherein said deblocking unit is operable to determine the energy of an area by determining the sum of the absolute values of the pixel values of the area, the sum of the square values of the pixel values of the area, or the sum of the absolution differences of consecutive pixel pairs with or without mean values of neighboring areas added.

16. A method of reducing blocking artifacts in a coded video signal comprising a plurality of video frames, comprising:
decomposing an input video frame by use of wavelet decomposition into at least two frequency bands,
detecting block borders in at least one high frequency band of said at least two frequency bands,
equalizing the energy of detected block borders with the energy of neighboring areas of the same high frequency band to obtain processed frequency bands to reduce blocking artifacts in said video frame, and
composing an output video frame from said input video frame and said processed frequency bands by use of wavelet composition.

17. An apparatus for reducing blocking artifacts in a coded video signal comprising a plurality of video frames, comprising:
a wavelet decomposition means for decomposing an input video frame by use of wavelet decomposition into at least two frequency bands,
a block grid detection means for detecting block borders in at least one high frequency band of said at least two frequency bands,
a deblocking means for equalizing the energy of detected block borders with the energy of neighboring areas of the same high frequency band to obtain processed frequency bands to reduce blocking artifacts in said video frame, and
a wavelet composition means for composing an output video frame from said input video frame and said processed frequency bands by use of wavelet composition.

18. A computer readable non-transitory medium having instructions stored thereon which, when carried out on a computer, cause the computer to perform the steps of the method as claimed in claim 16.
